(19) United States
(12) Patent Application Publication
(10) Pub. No.: US 2025/0226614 A1
(43) Pub. Date: Jul. 10, 2025

(54) FLOATING RADIO FREQUENCY CONNECTOR AND MATING FLOATING RADIO FREQUENCY CONNECTOR WITH OFFSET TOLERANCE

(71) Applicant: DONGGUAN LJV TECHNOLOGY CO., LTD, Dongguan (CN)

(72) Inventors: Cunka YANG, Dongguan (CN); Jianxin HE, Dongguan (CN)

(21) Appl. No.: 18/852,544

(22) PCT Filed: Dec. 9, 2022
(86) PCT No.: PCT/CN2022/137988

§ 371 Date: Sep. 30, 2024

(30) Foreign Application Priority Data
Apr. 1, 2022 (CN) 202210339683.8

(51) Int. Cl. H01R 13/631; H01R 24/40; H01R 103/00

(52) U.S. Cl. CPC H01R 13/6315; H01R 24/40; H01R 2103/00

(57) ABSTRACT

The present application discloses a floating radio frequency connector, comprising a fixed outer conductor, a floating outer conductor, an insulating inner core, and a conductive terminal, wherein the fixed outer conductor, the floating outer conductor, and the insulating inner core are coaxially arranged and form a floating central axis, the insulating inner core is arranged inside the floating outer conductor, the conductive terminal is inserted into and fixed inside the insulating inner core along the floating central axis, a lower end of the floating outer conductor is arranged inside the fixed outer conductor, the lower end of the floating outer conductor can swing around the floating central axis as a swing center, and the lower end of the floating outer conductor constantly abuts against the fixed outer conductor.

### CROSS-REFERENCE TO RELATED APPLICATIONS

The present application claims priority to Chinese Patent Application No. CN202210339683.8 with a filing date of Apr. 1, 2022 and entitled “FLOATING RADIO FREQUENCY CONNECTOR”, and to Chinese Patent Application No. CN202222866879.0 with a filing date of Oct. 30, 2022 and entitled “MATING FLOATING RADIO FREQUENCY CONNECTOR WITH LARGE OFFSET TOLERANCE”. The content of the aforementioned applications, including any intervening amendments thereto, is incorporated herein by reference.

### TECHNICAL FIELD

The present application relates to the technical field of radio frequency devices, and in particular, to a floating radio frequency connector.

### DESCRIPTION OF RELATED ART

The statement here only provides background information related to the present application and does not necessarily constitute the prior art.

With the rapid development of the communication industry and various electronic and electrical appliances, radio frequency connectors are widely used in various circuits. The existing radio frequency connectors are mainly coaxial radio frequency connectors, which mainly include insulators and inner conductors.

However, in an insertion process of a radio frequency connector and an external insert, coaxial insertion of the radio frequency connector and the external insert cannot be guaranteed. Therefore, the radio frequency connector and/or a terminal of the external insert and remaining parts are easily damaged, and later poor connection is difficult to discover due to the unstable structure after insertion.

### SUMMARY

The present application provides a floating radio frequency connector, including a fixed outer conductor, a floating outer conductor, an insulating inner core, and a conductive terminal, where the fixed outer conductor, the floating outer conductor, and the insulating inner core are coaxially arranged and form a floating central axis, the insulating inner core is arranged inside the floating outer conductor, the conductive terminal is inserted into and fixed inside the insulating inner core along the floating central axis, a lower end of the floating outer conductor is arranged inside the fixed outer conductor, the lower end of the floating outer conductor can swing around the floating central axis as a swing center, and the lower end of the floating outer conductor constantly abuts against the fixed outer conductor.

The lower end of the floating outer conductor of the floating radio frequency connector in the present application is arranged inside the fixed outer conductor, and the lower end of the floating outer conductor can swing around the floating central axis as the swing center, so that the floating outer conductor can swing to adapt to deviations caused by insertion of non-coaxial connection between the floating radio frequency connector and an external insert, thereby overcoming horizontal and angular offsets in the insertion process, to effectively ensure structural stability after the floating radio frequency connector is inserted into the external insert, and to avoid damage to the floating radio frequency connector and/or a terminal of the external insert and remaining parts due to insertion deviations in the insertion process.

The present application further provides a mating floating radio frequency connector with offset tolerance, including a fixed outer conductor, where a connecting portion for being welded with a substrate is arranged at a bottom of the fixed outer conductor, and a joint with a convex portion is arranged on a top of the fixed outer conductor; a floating outer conductor, where a sleeve in floating fit with the joint is arranged at a lower end of the floating outer conductor, and the sleeve is movably sleeved outside the joint; an insulator, where the insulator is provided with a slot that runs through axially, and the insulator is fixedly mounted inside the floating outer conductor; and a conductive terminal, where the conductive terminal is arranged inside the slot, a lower end of the conductive terminal extends out of the slot and is provided with a welding portion for connecting to the substrate, an upper portion of the conductive terminal is fixed with the insulator, and a middle portion of the conductive terminal is a flexible portion formed by bending.

The joint with a convex portion is arranged on the top of the fixed outer conductor in the present application, the sleeve in floating fit with the joint is arranged at the lower end of the floating outer conductor, and the sleeve is movably sleeved outside the joint, so that the fixed outer conductor has a smaller size; the sleeve elastically abuts against the joint, with simple structure and higher stability in conductive coordination; and the connecting portion for being welded with the substrate is arranged at the bottom of the fixed outer conductor, and the connecting portion is a flitch welding portion or a through plate welding pin arranged at a lower port of the fixed outer conductor, which has a simple structure and is convenient to produce.

### BRIEF DESCRIPTION OF THE DRAWINGS

FIG. 1 is a schematic structural diagram of a floating radio frequency connector of the present application;

FIG. 2 is a front view of a floating radio frequency connector of the present application;

FIG. 3 is an exploded view of FIG. 2;

FIG. 4 is a schematic structural diagram when a floating radio frequency connector is to be inserted into an external insert according to the present application;

FIG. 5 is a schematic structural diagram after a floating radio frequency connector is inserted into an external insert according to the present application;

FIG. 6 is a schematic structural diagram when a floating radio frequency connector abuts against a guide slope of an external insert according to the present application;

FIG. 7 is a schematic structural diagram of a floating radio frequency connector preliminarily guided into an inlet of an insertion cavity under action of a guide slope of an external insert according to the present application;

FIG. 8 is a partial cross-sectional view of the floating radio frequency connector in FIG. 7;

FIG. 9 is a schematic structural diagram of a floating radio frequency connector fully guided into an insertion cavity under action of a guide slope of an external insert according to the present application;

FIG. 10 is a schematic structural diagram of a preferred structure of a conductive terminal of the present application;

FIG. 11 is a schematic structural diagram of a preferred structure of a conductive terminal of the present application;

FIG. 12 is a schematic structural diagram of a preferred structure of a conductive terminal of the present application;

FIG. 13 is a schematic structural diagram of a preferred structure of a conductive terminal of the present application;

FIG. 14 is a schematic structural diagram of a preferred structure of a conductive terminal of the present application;

FIG. 15 is a schematic structural diagram of a preferred structure of a conductive terminal of the present application;

FIG. 16 is a schematic structural diagram of a first embodiment of a radio frequency connector;

FIG. 17 is a first schematic structural diagram exploded from FIG. 16;

FIG. 18 is a second schematic structural diagram exploded from FIG. 16;

FIG. 19 is a schematic structural diagram of a second embodiment of a radio frequency connector;

FIG. 20 is a schematic diagram of a three-dimensional structure of a fixed outer conductor in the second embodiment of FIG. 18;

FIG. 21 is a front view of an assembly structure of the second embodiment in FIG. 19, a substrate, and an external insert;

FIG. 22 is a first schematic diagram of an assembly structure of a floating outer conductor, an insulator, and a conductive terminal;

FIG. 23 is a second schematic diagram of an assembly structure of a floating outer conductor, an insulator, and a conductive terminal;

FIG. 24 is a schematic diagram of an assembly structure of the floating outer conductor in FIG. 22 or FIG. 23 and an external insert;

FIG. 25 is a first schematic diagram of an assembly structure of a floating outer conductor, an insulator, and a conductive terminal;

FIG. 26 is a second schematic diagram of an assembly structure of a floating outer conductor, an insulator, and a conductive terminal;

FIG. 27 is a schematic diagram of an assembly structure of the floating outer conductor in FIG. 24 or FIG. 25 and an external insert; and

FIG. 28 is a schematic structural diagram of a conductive terminal with a female terminal.

### DETAILED DESCRIPTION OF THE EMBODIMENTS

In order to facilitate understanding of the present application, the present application will be explained in more detail below with reference to the accompanying drawings and specific embodiments. It should be noted that when an element is expressed to be “fixed” to another element, the element may be directly on the other element, or there may be one or more medium elements between them. When an element is expressed to be “connected” to another element, the element may be directly connected to the other element, or there may be one or more medium elements between them. The terms “vertical”, “horizontal”, “left”, “right”, “inner”, “outer”, and similar expressions used in the specification are merely for illustrative purposes. In the description of the present application, the terms “first” and “second” are merely used for descriptive purposes and cannot be understood as indicating relative importance or implying a quantity of indicated technical features. Therefore, unless otherwise specified, features limited to “first” or “second” may explicitly or implicitly include one or more of these features; and the meaning of “a plurality of” is two or more. The term “include” and any variations thereof mean non-exclusive inclusion, which may include or add one or more other features, integers, steps, operations, units, components, and/or combinations thereof.

In addition, unless otherwise specified and limited, the terms “mounted”, “connected”, and “connection” should be understood broadly, for example, the “connection” may be fixed connection, detachable connection, integral connection, mechanical connection, electrical connection, direct connection, or connection by a medium, or internal communication between two elements. All technical and scientific terms used in the specification have the same meanings as those commonly understood by those skilled in the art. The terms used in the specification of the present application are merely for the purpose of describing specific embodiments and are not intended to limit the present application. The term “and/or” used in the specification includes any and all combinations of one or more relevant listed items.

Moreover, the technical features involved in different embodiments of the present application described below can be combined with each other as long as they do not conflict with each other.

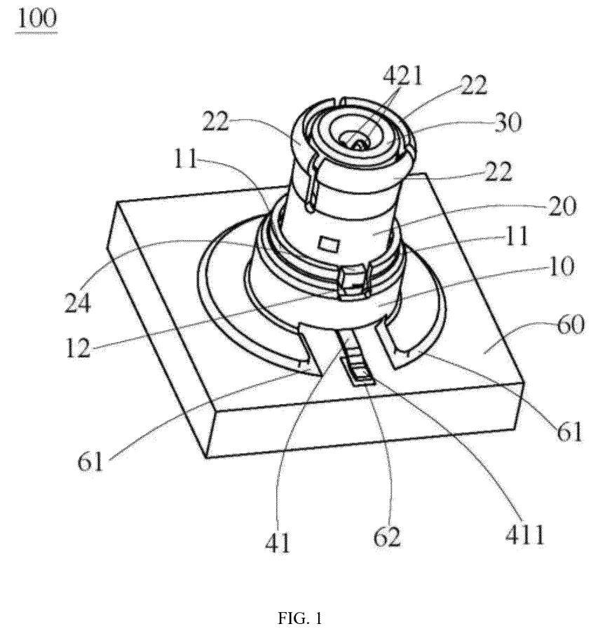

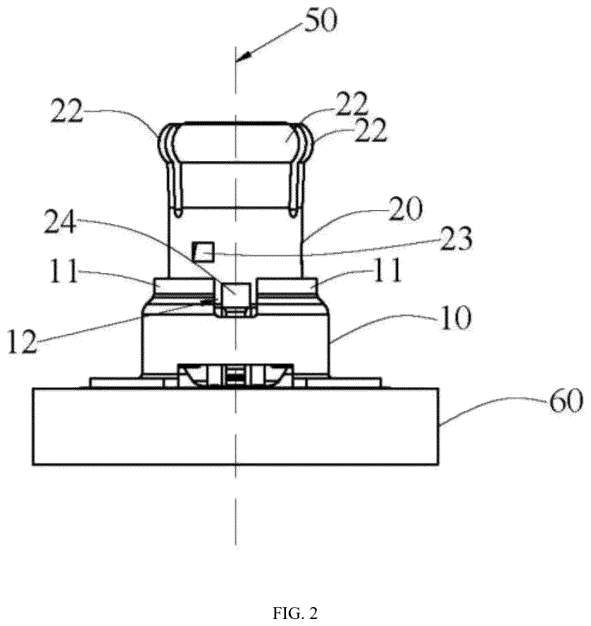

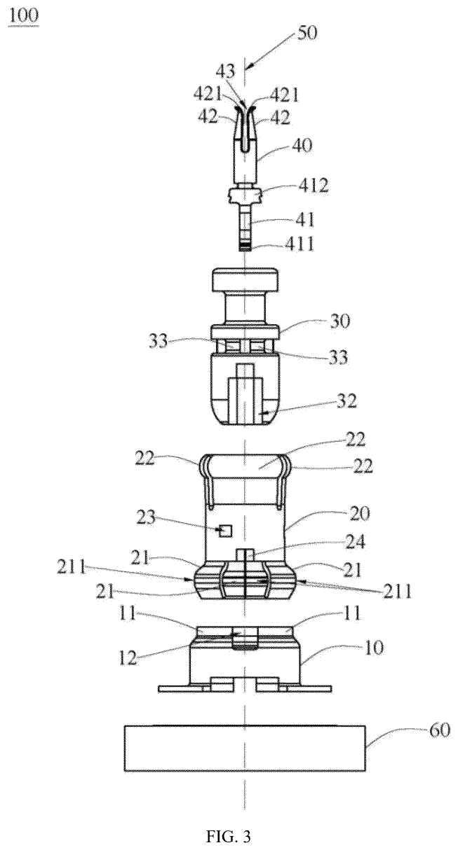

As shown in FIG. 1 to FIG. 5, a floating radio frequency connector 100 in this embodiment includes a fixed outer conductor 10, a floating outer conductor 20, an insulating inner core 30, and a conductive terminal 40, where the fixed outer conductor 10, the floating outer conductor 20, and the insulating inner core 30 are coaxially arranged and form a floating central axis 50, the insulating inner core 30 is arranged inside the floating outer conductor 20, and the conductive terminal 40 is inserted into and fixed inside the insulating inner core 30 along the floating central axis 50. Here, a socket of the insulating inner core 30 for inserting the conductive terminal 40 is circular or square.

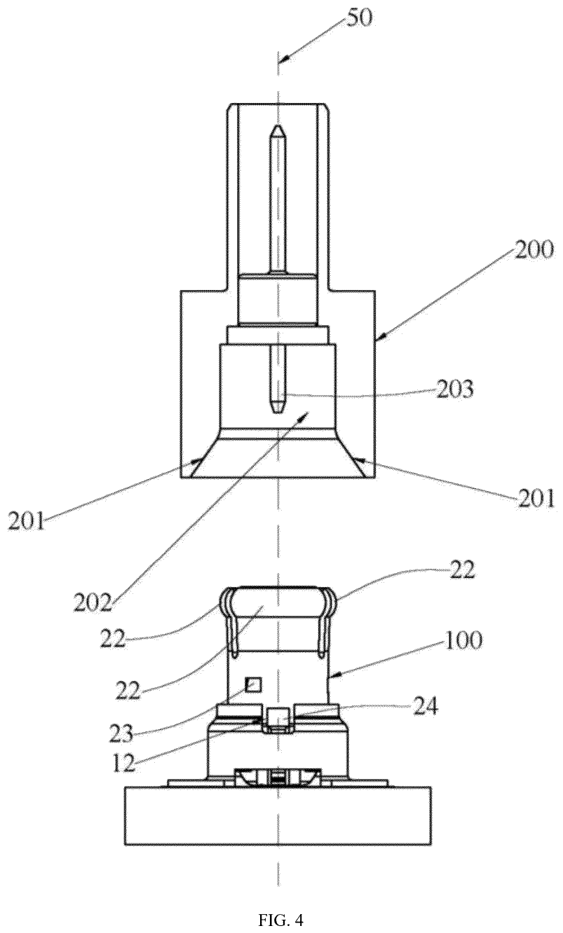

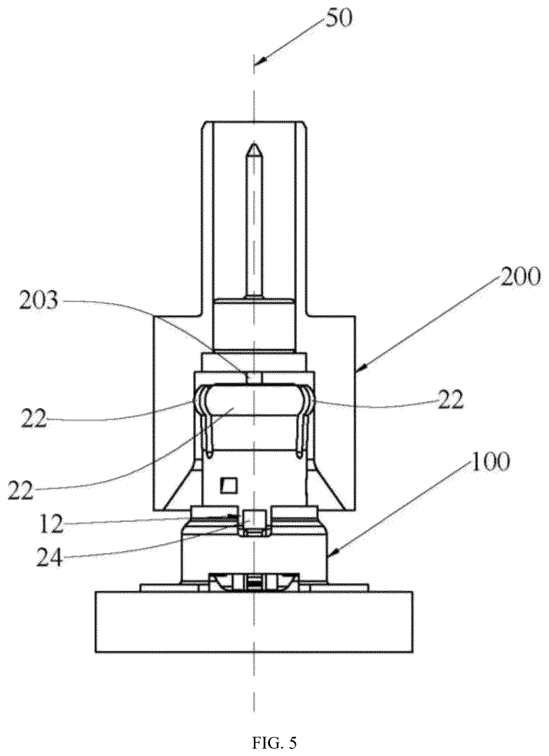

It can be understood that the fixed outer conductor 10, the floating outer conductor 20, and the conductive terminal 40 are all conductive metal parts, and the insulating inner core 30 is a non-conductive plastic insulating part. The fixed outer conductor 10, the floating outer conductor 20, and the insulating inner core 30 are coaxially arranged, so that the floating radio frequency connector 100 in this embodiment is a coaxial radio frequency connector. The floating central axis 50 here is a common axis of the fixed outer conductor 10, the floating outer conductor 20, and the insulating inner core 30 in a coaxial state after ideal insertion of an insert as shown in FIG. 4 and FIG. 5. The structure of the floating radio frequency connector 100 in this embodiment will be described below with the floating central axis 50 as a reference position.

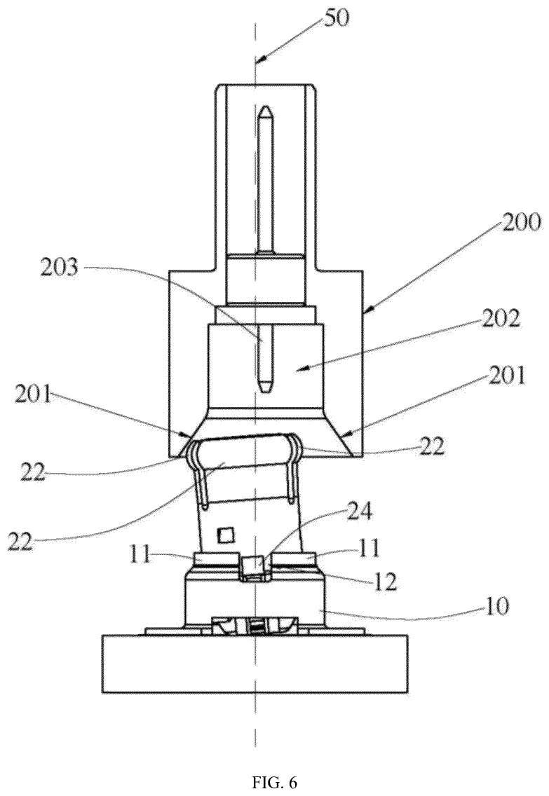

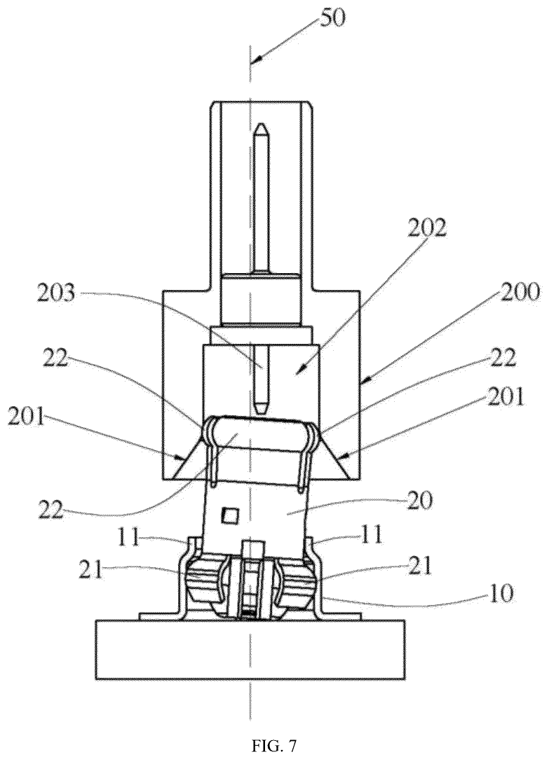

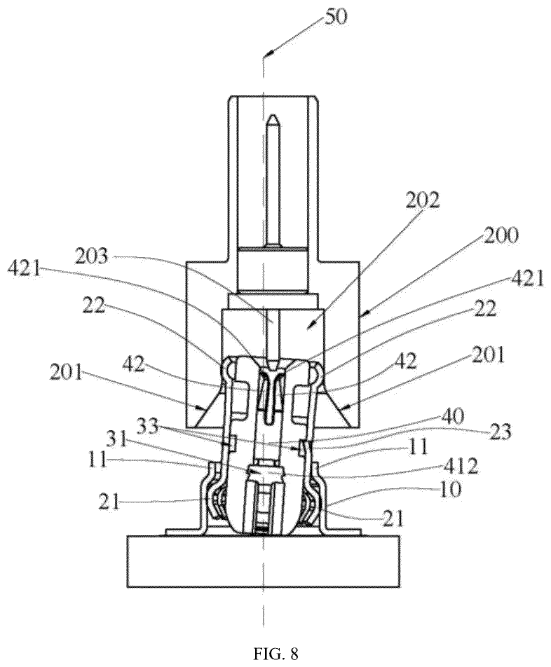

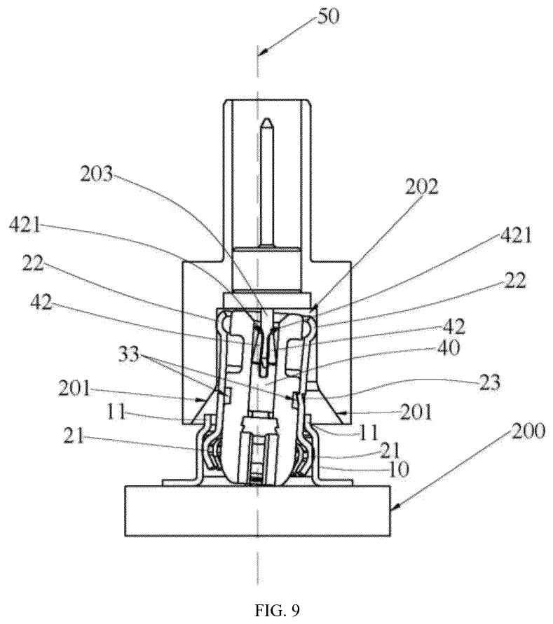

As shown in FIG. 1 to FIG. 9, a lower end of the floating outer conductor 20 in this embodiment is arranged inside the fixed outer conductor 10, the lower end of the floating outer conductor 20 can swing around the floating central axis 50 as a swing center, and the lower end of the floating outer conductor 20 constantly abuts against the fixed outer conductor 10. It can be understood that when the lower end of the floating outer conductor 20 swings around the floating central axis 50, since the floating outer conductor 20 and the insulating inner core 30 are fixedly arranged, and the floating outer conductor 20 and the insulating inner core 30 are coaxial, but not coaxial with the fixed outer conductor 10, axes of the floating outer conductor 20 and the insulating inner core 30 have an angle of greater than 0° and less than 90° with the floating central axis 50, specifically shown in FIG. 6 to FIG. 9. In addition, because both the fixed outer conductor 10 and the floating outer conductor 20 are conductive metal parts, the lower end of the floating outer conductor 20 constantly abuts against the fixed outer conductor 10 to achieve a constant electrical connection between the floating outer conductor 20 and the fixed outer conductor 10. It should be noted that the insulating inner core 30 here may be of an integrated structure or a split structure. When the insulating inner core 30 is of the split structure, all portions of the insulating inner core 30 can be combined into the insulating inner core 30 by riveting, clamping, bonding, bolts, or the like, which will not be elaborated here.

As shown in FIG.1 to FIG. 9, the lower end of the floating outer conductor 20 in this embodiment extends away from the floating central axis 50 in a radial direction of the floating central axis 50 and is bent to form a first elastic guide portion 21, the first guide portion 21 is cambered, and the first guide portion 21 is in interference fit with the fixed outer conductor 10, so that the first guide portion 21 constantly abuts against the fixed outer conductor 10. The first guide portion 21 is elastic and cambered, an outer wall of the first guide portion 21 constantly abuts against an inner wall of the fixed outer conductor 10, and the first guide portion 21 can provide some guidance and support for swing, thereby ensuring a smooth swing process. FIG. 6 to FIG. 9 show actions between the first guide portion 21 and the fixed outer conductor 10.

In addition, due to the elasticity of the first guide portion 21, the lower end of the floating outer conductor 20 capable of making adaptive elastic deformation in the swing process, so that the swinging floating outer conductor 20 can overcome horizontal and angular offsets in the insertion process, to effectively ensure structural stability after the floating radio frequency connector 100 is inserted into an external insert 200, and to avoid damage to the floating radio frequency connector 100 and/or a terminal 203 of the external insert 200 and remaining parts due to insertion deviations in the insertion process.

Further, in order to ensure that the first guide portion 21 can provide isotropic elastic force and support force in the swing process, the first guide portion 21 in this embodiment is composed of a plurality of first arc-shaped elastic sheets spaced at the lower end of the floating outer conductor 20. The spacing between the first arc-shaped elastic sheets can be adjusted according to actual needs and is not limited here.

Furthermore, the first guide portion 21 is provided with a return plane 211, and the return plane 211 is flat. Preferably, the return plane 211 is arranged at a cambered peak position of the first guide portion 21, so that after the floating radio frequency connector 100 is inserted into the external insert 200 and external force (externally applied insertion force) is withdrawn, the first guide portion 21 can return under the action of the return plane 211 to fit on the inner wall of the fixed outer conductor 10, and the floating outer conductor 20 remains perpendicular to a floating plate 60 or the floating outer conductor 20 constantly tends to remain perpendicular to the floating plate 60.

As shown in FIG. 1 to FIG. 9, an upper end of the floating outer conductor 20 in this embodiment extends away from the floating central axis 50 in the radial direction of the floating central axis 50 and is bent to form a second elastic guide portion 22, the second guide portion 22 is cambered, a guide slope 201 is formed at an inlet of an insertion cavity 202 of the external insert 200, and when the floating radio frequency connector 100 is inserted into the external insert 200, the second guide portion 22 is guided into the insertion cavity 202 along the guide slope 201 and constantly abuts against an inner wall of the insertion cavity 202. FIG. 6 to FIG. 9 show actions of the second guide portion 22.

It can be understood that when the floating radio frequency connector 100 is inserted into the external insert 200, a horizontal offset and/or an angular offset as shown in FIG. 6 to FIG. 9 occur. In this case, the guide slope 201 squeezes the second guide portion 22, and the second guide portion 22 is deformed by force and guided into the insertion cavity 202 under the action of the guide slope 201. When the second guide portion 22 fully enters the insertion cavity 202, the second guide portion 22 constantly abuts against the inner wall of the insertion cavity 202 under elastic action, so that the upper end of the floating outer conductor 20 is fixedly inserted into the insertion cavity 202 of the external insert 200.

Further, in order to ensure that the second guide portion 22 can provide isotropic elastic force and support force in the swing process, the second guide portion 22 in this embodiment is composed of a plurality of second arc-shaped elastic sheets spaced at the upper end of the floating outer conductor 20. The spacing between the second arc-shaped elastic sheets can be adjusted according to actual needs and is not limited here.

As shown in FIG. 1 to FIG. 9, an upper end of the fixed outer conductor 10 in this embodiment extends close to the floating central axis 50 in the radial direction of the floating central axis 50 and is bent to form a limit boss 11, and the fixed outer conductor 10 limits a swing amplitude of the floating outer conductor 20 through the limit boss 11. In practical use, a height of the limit boss 11 can be set according to a model of the floating radio frequency connector 100 to limit a maximum swing amplitude.

Alternatively, in other preferred manners, the swing amplitude of the floating outer conductor 20 can be limited only by adjusting a gap between the floating outer conductor 20 and the fixed outer conductor 10. Alternatively, the swing amplitude of the floating outer conductor 20 can be jointly limited by setting the limit boss 11 and adjusting the gap between the floating outer conductor 20 and the fixed outer conductor 10, which will not be repeated here.

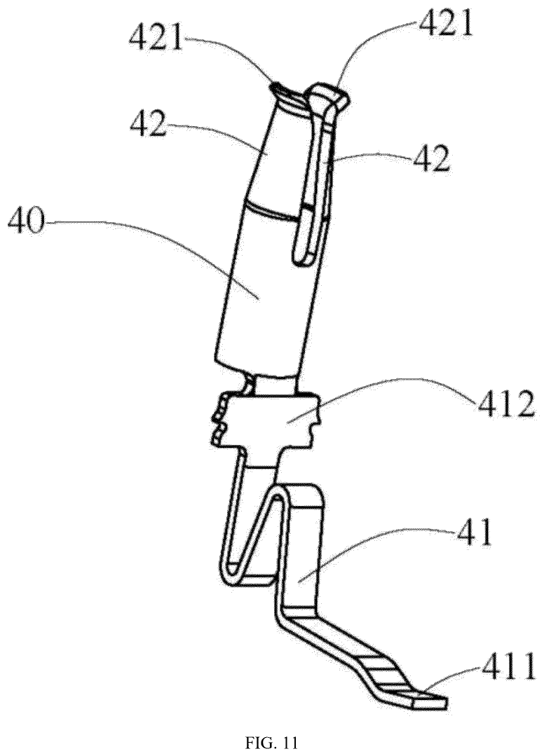

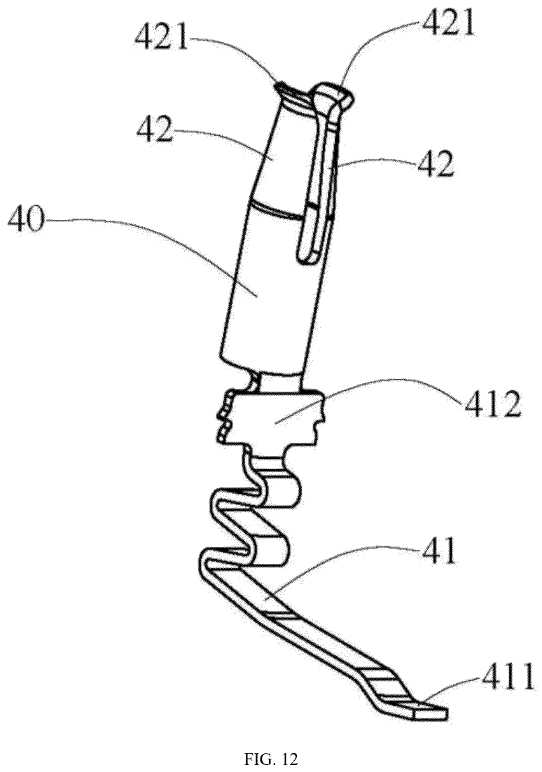

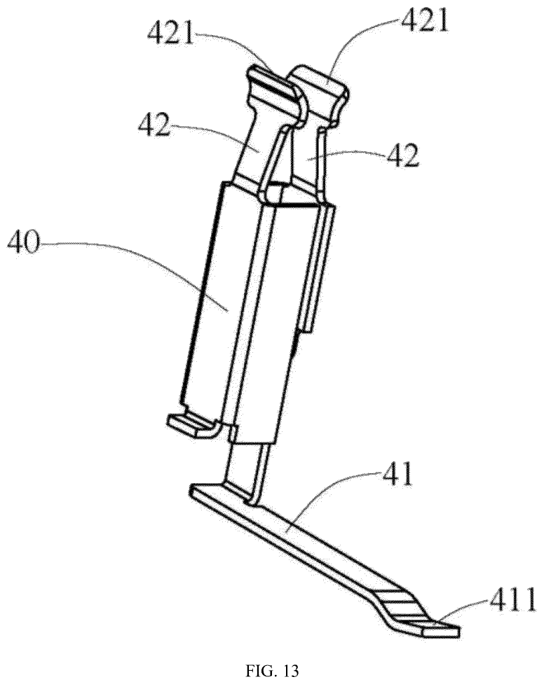

With reference to FIG. 1 to FIG. 15, the floating radio frequency connector 100 in this embodiment further includes a floating plate 60, a first pad 61 is arranged on the floating plate 60, and the fixed outer conductor 10 is welded and fixed to the floating plate 60 through the first pad 61. Preferably, the fixed outer conductor 10 is of an integrated structure, and the first pad 61 is arranged as an integrated structure being annular strip-shaped on the floating plate 60, or as a split structure on the floating plate 60. Further, the fixed outer conductor 10 is welded to the floating plate 60 in a fit manner, the floating plate 60 is provided with a sunken groove for placing the first pad 61, and the first pad 61 placed in the sunken groove is flush with a surface of the floating plate 60.

In other embodiments, the fixed outer conductor 10 is of a split structure. For example, the fixed outer conductor 10 is composed of two conductive metal blocks fixed by riveting, buckles, or screws. In this case, the first pad 61 is arranged as a split structure on the floating plate 60. Alternatively, the fixed outer conductor 10 may be composed of more conductive metal blocks, which will not be repeated here.

Preferably, a second pad 62 is further arranged on the floating plate 60, a lower end of the conductive terminal 40 extends towards the second pad 62 and is bent to form a terminal pin 41, and a welding portion 411 is arranged at an end of the terminal pin 41. When the conductive terminal 40 is fixed inside the insulating inner core 30, the terminal pin 41 passes through the insulating inner core 30 and extends out from a lower end of the insulating inner core 30. The conductive terminal 40 is welded and fixed to the floating plate 60 through the second pad 62.

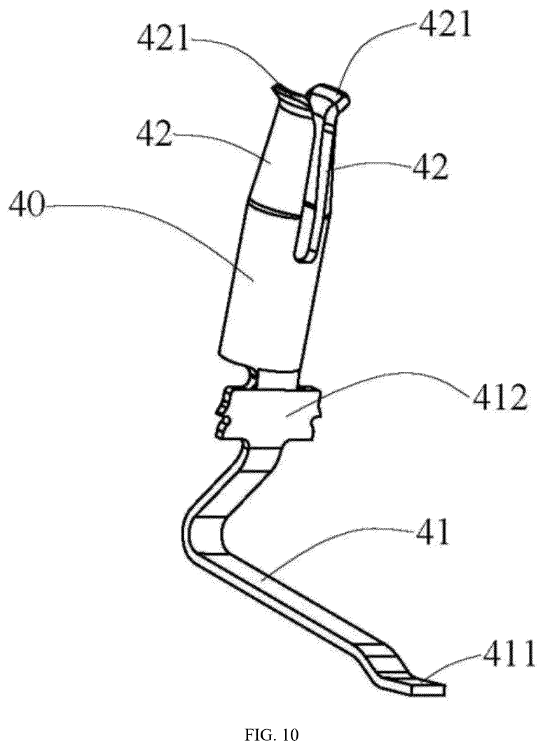

Preferably, the terminal pin 41 is flexibly arranged to absorb swing deformation of the conductive terminal 40. It can be understood that the terminal pin 41 is welded and fixed to the floating plate 60, and the terminal pin 41 deforms relative to the floating plate 60 in the swing process, so the terminal pin 41 is flexibly arranged to absorb its swing deformation through deformation, thereby ensuring stable welding between the terminal pin 41 and the floating plate 60. FIG. 10 to FIG. 15 show various structural forms of the conductive terminal 40, with elastic terminal sheets 42 bent in a right angle, an acute angle, a single wave, multiple waves, or the like, to provide enough flexible deformation, so as to enable the terminal pin 41 to absorb its swing deformation through deformation.

Preferably, the terminal pin 41 is provided with a barbed portion 412, the insulating inner core 30 is provided with a barbed clamping groove 31 matching the barbed portion 412 and an avoidance gap 32 for an extension of the terminal pin 41, and the avoidance gap 32 is arranged on a lower side wall of the insulating inner core 30. When the conductive terminal 40 is fixed inside the insulating inner core 30, the barbed portion 412 is clamped and fixed inside the barbed clamping groove 31, and the terminal pin 41 extends out from the lower side wall of the insulating inner core 30 through the avoidance gap 32, to reduce the overall length of the floating radio frequency connector 100. In addition, in other preferred manners, the conductive terminal 40 may be provided with a protrusion or other structure to replace the barbed portion 412, so as to limit and fix the conductive terminal 40 inside the insulating inner core 30. In this case, the structure of the barbed clamping groove 31 of the insulating inner core 30 is required to be adjusted adaptively.

As shown in FIG. 1 to FIG. 15, two opposite elastic terminal sheets 42 are arranged at an upper end of the conductive terminal 40 in this embodiment, a receiving cavity 43 for inserting the terminal 203 of the external insert 200 is formed between the two elastic terminal sheets 42, and when the terminal 203 of the external insert 200 is inserted into the receiving cavity 43, the two elastic terminal sheets 42 jointly clamp the terminal 203 of the external insert 200, thereby ensuring a stable electrical connection between the floating radio frequency connector 100 and the external insert 200. In other preferred manners, the quantity of the elastic terminal sheets 42 may be three or more. In this case, all the elastic terminal sheets 42 are spaced at the upper end of the conductive terminal 40, all the elastic terminal sheets 42 jointly form a receiving cavity 43 for inserting the terminal 203 of the external insert 200, and when the terminal 203 of the external insert 200 is inserted into the receiving cavity 43, all the elastic terminal sheets 42 jointly clamp the terminal 203 of the external insert 200, thereby ensuring a stable electrical connection between the floating radio frequency connector 100 and the external insert 200. The quantity of the elastic terminal sheets 42 may be set according to actual needs and is not limited here.

Preferably, the elastic terminal sheet 42 extends radially away from the floating central axis 50 and is bent to form a third elastic guide portion 421, the third guide portion 421 is cambered, and when the terminal 203 of the external insert 200 is inserted into the receiving cavity 43, the terminal 203 of the external insert 200 is guided into the receiving cavity 43 along the third guide portion 421.

It can be understood that when the floating radio frequency connector 100 is inserted into the external insert 200 with a horizontal offset and/or an angular offset, the terminal 203 of the external insert 200 may abut against the third guide portion 421 of the elastic terminal sheet 42. In this case, the third guide portion 421 guides the terminal 203 of the external insert 200 into the receiving cavity 43, and ultimately the two elastic terminal sheets 42 jointly stably clamp the terminal 203 of the external insert 200. FIG. 6 to FIG. 9 show actions of the third guide portion 421.

As shown in FIG.1 to FIG. 9, the floating radio frequency connector 100 in this embodiment further includes a first anti-rotating structure and a second anti-rotating structure, and the first anti-rotating structure is used for limiting rotation between the floating outer conductor 20 and the insulating inner core 30 to ensure a stable connection between the terminal pin 41 and the second pad 62. Specifically, the first anti-rotating structure includes a plurality of first grooves 33 and a plurality of first protrusions 23, the first grooves 33 are arranged on the floating outer conductor 20 or the insulating inner core 30, and the first protrusions 23 are arranged on the insulating inner core 30 or the floating outer conductor 20. It can be understood that all the first grooves 33 are arranged on the floating outer conductor 20 or the insulating inner core 30, and all the first protrusions 23 are arranged at positions corresponding to the grooves 33 on the insulating inner core 30 or the floating outer conductor 20. In other embodiments, the grooves 33 may be arranged on the floating outer conductor 20 and the insulating inner core 30 respectively, and the protrusions 23 may be arranged on the floating outer conductor 20 and the insulating inner core 30 respectively, without any limitations here. In other embodiments, the first anti-rotating structure may limit the rotation between the floating outer conductor 20 and the insulating inner core 30 by bonding, magnetic attraction, welding, bolts, or the like, which will not be elaborated here.

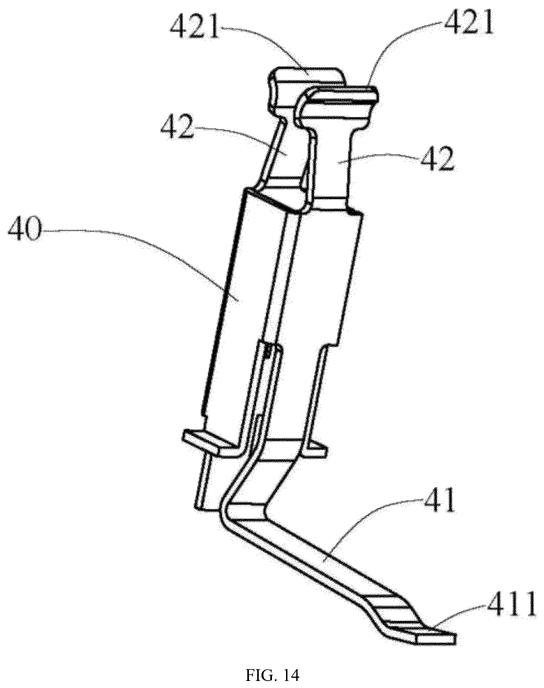

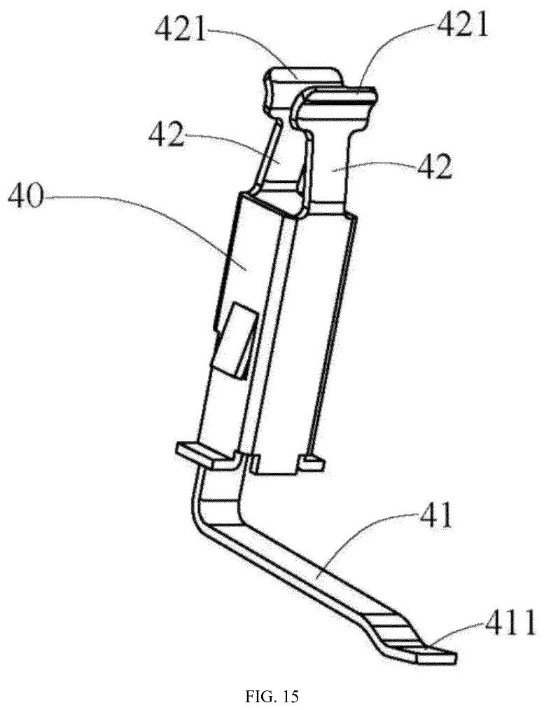

FIG. 14 and FIG. 15 show a schematic structure of an anti-rotating fit state when the first grooves 33 are arranged on the insulating inner core 30 and the first protrusions 23 are arranged at the positions corresponding to the first grooves 33 on the floating outer conductor 20. When the insulating inner core 30 is arranged inside the floating outer conductor 20, the insulating inner core 30 is limited and stops rotating by the first grooves 33 and the first protrusions 23, to avoid separation of the terminal pin 41 from the second pad 62 due to relative rotation of the insulating inner core 30 and the floating outer conductor 20 subsequently.

It should be noted that the first grooves 33 and the first protrusions 23 can be spaced on side walls of corresponding components to satisfy anti-rotating limits on each side, thereby improving the anti-rotating capability.

The second anti-rotating structure includes a second protrusion 24 and an avoidance gap 12, the second protrusion 24 is arranged on the floating outer conductor 20, the avoidance gap 12 is formed on the fixed outer conductor 10, and width of the second protrusion 24 is less than that of the avoidance gap 12, so that when the floating outer conductor 20 swings relative to the fixed outer conductor 10, the floating outer conductor 20 drives the second protrusion 24 to synchronously swing within the avoidance gap 12. By reasonably setting a width difference between the second protrusion 24 and the avoidance gap 12, a swing angle of the floating outer conductor 20 relative to the fixed outer conductor 10 can be accurately limited. FIG. 6 shows a schematic diagram of limiting the swing angle of the floating outer conductor 20 relative to the fixed outer conductor 10 under the cooperation of the second protrusion 24 and the avoidance gap 12. And the second anti-rotating structure may be a slide rail structure or a pulling structure with limited travel, or the like, without any limitations here.

With reference to FIG. 1 to FIG. 15, the lower end of the floating outer conductor 20 of the floating radio frequency connector 100 in the present application is arranged inside the fixed outer conductor 10, and the lower end of the floating outer conductor 20 can swing around the floating central axis 50 as the swing center, so that the floating outer conductor 20 can swing to adapt to deviations caused by insertion of non-coaxial connection between the floating radio frequency connector 100 and the external insert 200, thereby overcoming horizontal and angular offsets in the insertion process, to effectively ensure the structural stability after the floating radio frequency connector 100 is inserted into the external insert 200, and to avoid damage to the floating radio frequency connector 100 and/or the terminal 203 of the external insert 200 and remaining parts due to insertion deviations in the insertion process.

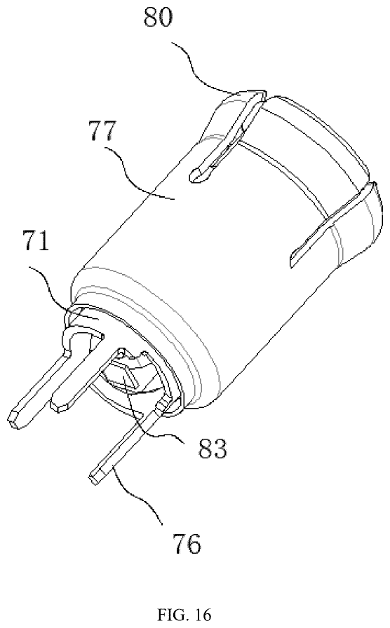

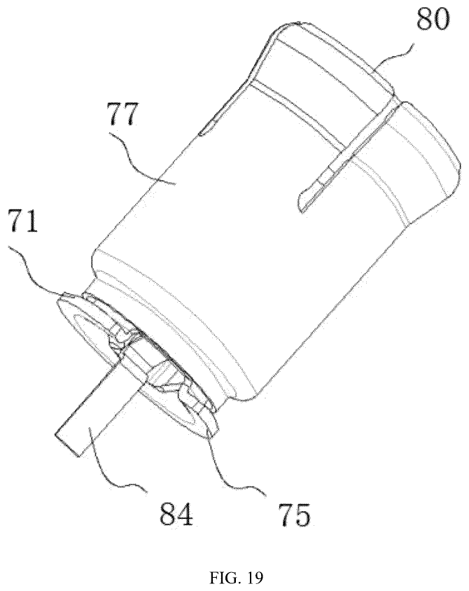

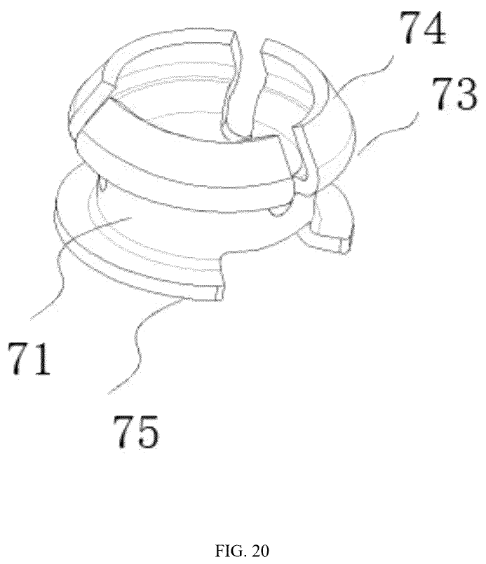

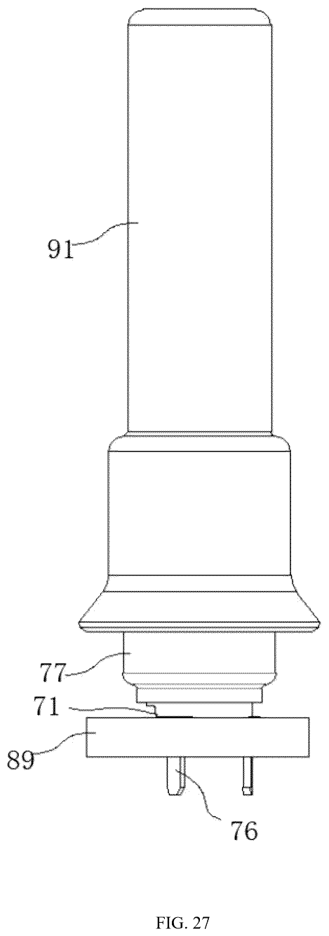

With reference to FIG. 16 to FIG. 28, in another embodiment, a mating floating radio frequency connector with offset tolerance includes a fixed outer conductor 71, a floating outer conductor 77, an insulator 81, and a conductive terminal 83. A connecting portion 72 for being welded with a substrate is arranged at a bottom of the fixed outer conductor 71, and a joint 73 with a convex portion is arranged on a top of the fixed outer conductor 71. A sleeve 78 in floating fit with the joint 73 is arranged at a lower end of the floating outer conductor 77, and the sleeve 78 is movably sleeved outside the joint 73. The insulator 81 is provided with a slot 82 that runs through axially, and the insulator 81 is fixedly mounted inside the floating outer conductor 77. The conductive terminal 83 is arranged inside the slot 82, a lower end of the conductive terminal 83 extends out of the slot 82 and is provided with a welding portion 84 for connecting to the substrate, an upper portion of the conductive terminal 83 is fixed with the insulator 81, and a middle portion of the conductive terminal 83 is a flexible portion 85 formed by bending.

The joint on the fixed outer conductor 71 is implemented in many ways. In a first way, a plurality of first elastic sheets 74 are arranged on the top of the fixed outer conductor 71, the joint 73 can be formed by bending middle portions of the plurality of first elastic sheets 74 outward respectively, and convex portions in the middle portions of the plurality of first elastic sheets 74 can elastically abut against an inner wall of the sleeve 78.

In a second way, a hollow spherical crown (not shown) is arranged on the top of the fixed outer conductor 71, and a convex portion at a maximum outer diameter of the spherical crown can abut against the inner wall of the sleeve 78 in a sliding manner. Further improvement is made to the second way: a second elastic sheet bent inward (not shown) is arranged on the sleeve 78, and the spherical crown can elastically abut against the second elastic sheet.

In order to limit detachment of the floating outer conductor 77 from the fixed outer conductor 71 and a swing amplitude, a limit portion 79 bent inward is arranged at an opening of the sleeve 78.

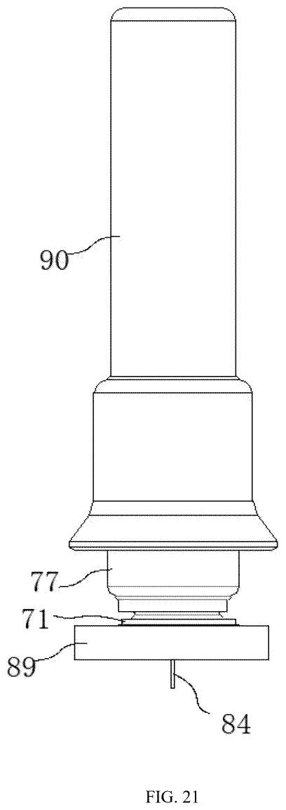

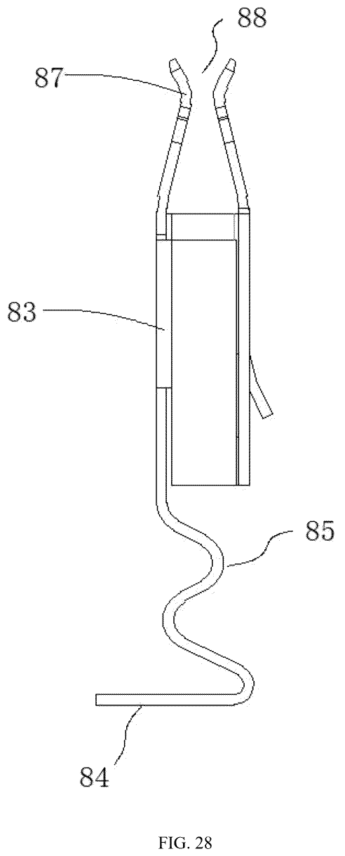

In the present application, the fixed outer conductor 71 is of a hollow structure with openings at two ends, and the connecting portion 72 is a flitch welding portion 75 or a through plate welding pin 76 arranged at a lower port of the fixed outer conductor 71. FIG. 21 is a front view of an assembly structure of the fixed outer conductor 71 with the flitch welding portion 75, a substrate 89, and an external insert 90. FIG. 28 is a front view of an assembly structure of the fixed outer conductor 71 with the through plate welding pin 76, a substrate 89, and an external insert 90.

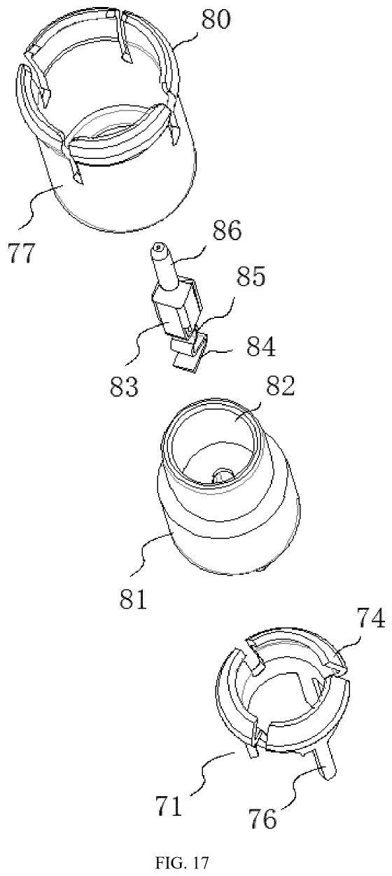

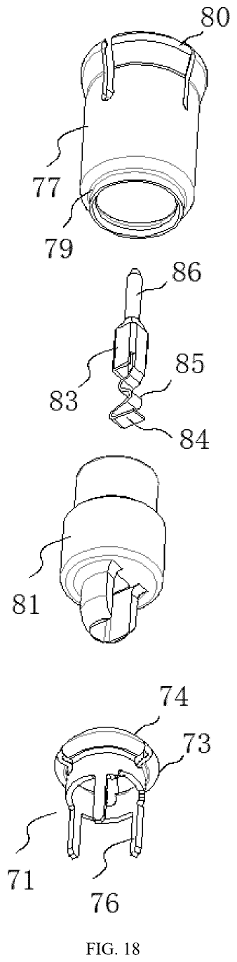

In the present application, a terminal of the conductive terminal 83 is a pin 86 (as shown in FIG. 17 and FIG. 18) or a female terminal 87 with a chamber 88 (as shown in FIG. 28). The floating outer conductor 77 is of a hollow structure with openings at two ends. An upper portion of the floating outer conductor 77 is implemented in many ways. In a first way, a third elastic sheet 80 protruding outward is arranged at the upper portion of the floating outer conductor 77, the third elastic sheet 80 is bent, and an end of the third elastic sheet 80 is a free end. In a second way, the upper portion of the floating outer conductor 77 is an end portion of a cylindrical shell. Two types of conductive terminals 83 with different structures and two types of floating outer conductors 77 with different structures are combined to form the following four implementations:

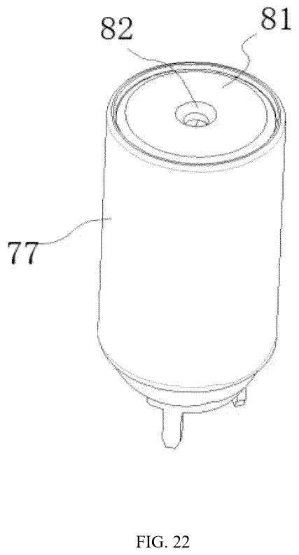

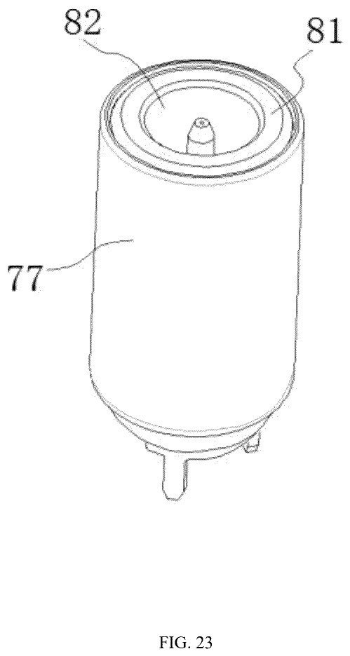

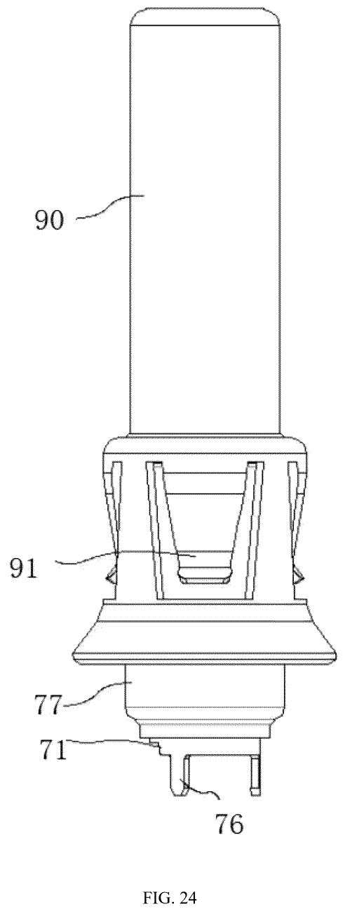

In the present application, the upper portion of the floating outer conductor 77 is a cylindrical shell (as shown in FIG. 22 and FIG. 23), and the terminal of the conductive terminal 83 is a pin 86 or a female terminal 87 with a chamber 88. When the two types of floating outer conductors 77 are mated with a housing of the external insert 90, in order to maintain stable elastic abutment, a fourth elastic sheet 91 bent inward is arranged on the housing of the external insert 90 (as shown in FIG. 24). When the upper portion of the floating outer conductor 77 slides into the housing of the external insert 90, the fourth elastic sheet 91 elastically abuts against an outer side of the floating outer conductor 77 to achieve a stable electrical connection.

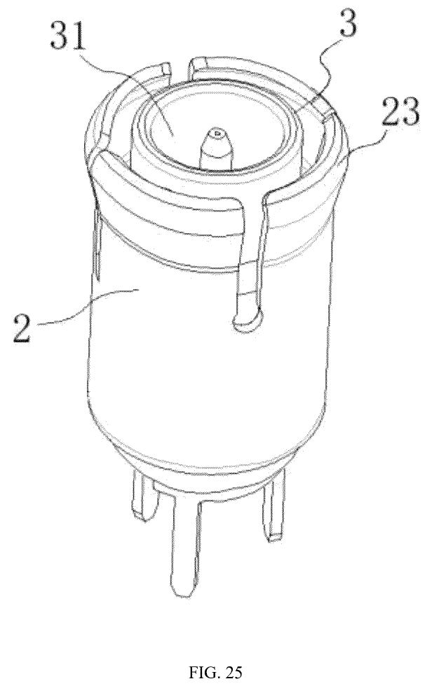

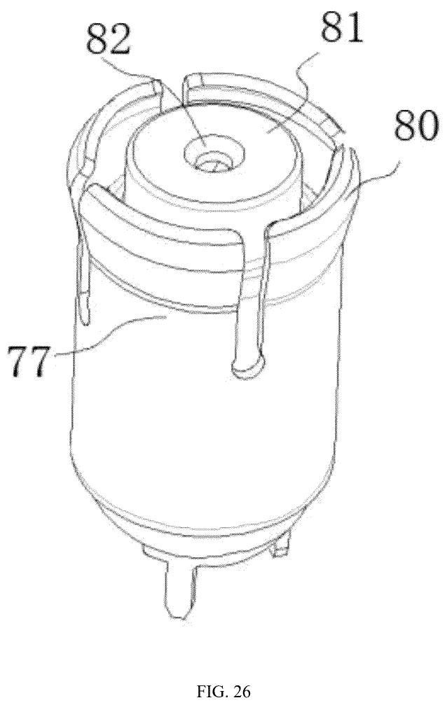

In the present application, a third elastic sheet 80 protruding outward is arranged at the upper portion of the floating outer conductor 77 (as shown in FIG. 25 and FIG. 26), and the terminal of the conductive terminal 83 is a pin 86 or a female terminal 87 with a chamber 88. When the upper portion of the floating outer conductor 77 slides into the housing of the external insert 90, the third elastic sheet 80 elastically abuts against an inner wall of the housing of the external insert 90 to achieve a stable electrical connection.

The lower portion of the floating outer conductor 77 in the present application is sleeved outside the joint 73 on the fixed outer conductor 71 in a floating manner, and the floating outer conductor 77 can swing to adapt to a horizontal offset and an angular offset in the insertion process of the floating radio frequency connector and the external insert 90, so as to effectively ensure structural stability after the floating connector is inserted into the external insert 90 and also avoid damage to the floating radio frequency connector and/or a conductive terminal of the external insert 90 and remaining parts due to insertion deviations. Moreover, the floating outer conductor 77 and the fixed outer conductor 71 form a shielding outer layer, which can well shield electromagnetic interference.

The above embodiments are merely used for illustrating, rather than limiting the technical solutions of the present application; under the ideas of the present application, the above embodiments or the technical features in different embodiments can also be combined, the steps can be implemented in any order, and there are many other changes in different aspects of the present application as described above, which are not provided in detail for simplicity; although the present application is described in detail with reference to the foregoing embodiments, those of ordinary skill in the art should understand that they can still modify the technical solutions recorded in the foregoing embodiments or equivalently replace some of the technical features; and these modifications or replacements do not make the essences of the corresponding technical solutions deviate from the scope of the technical solutions of the embodiments of the present application.

1. A floating radio frequency connector, comprising a fixed outer conductor, a floating outer conductor, an insulating inner core, and a conductive terminal, wherein the fixed outer conductor, the floating outer conductor, and the insulating inner core are coaxially arranged and form a floating central axis, the insulating inner core is arranged inside the floating outer conductor, the conductive terminal is inserted into and fixed inside the insulating inner core along the floating central axis, a lower end of the floating outer conductor is arranged inside the fixed outer conductor, the lower end of the floating outer conductor can swing around the floating central axis as a swing center, and the lower end of the floating outer conductor constantly abuts against the fixed outer conductor.

2. The floating radio frequency connector of claim 1, wherein the lower end of the floating outer conductor extends away from the floating central axis in a radial direction of the floating central axis and is bent to form a first elastic guide portion, the first guide portion is cambered, and the first guide portion is in interference fit with the fixed outer conductor, so that the first guide portion constantly abuts against the fixed outer conductor.

3. The floating radio frequency connector of claim 1, wherein an upper end of the fixed outer conductor extends close to the floating central axis in the radial direction of the floating central axis and is bent to form a limit boss, and the fixed outer conductor limits a swing amplitude of the floating outer conductor through the limit boss.

4. The floating radio frequency connector of claim 1, wherein the floating radio frequency connector further comprises a floating plate, a first pad is arranged on the floating plate, and the fixed outer conductor is welded and fixed to the floating plate through the first pad.

5. The floating radio frequency connector of claim 4, wherein a second pad is further arranged on the floating plate, a lower end of the conductive terminal extends towards the second pad and is bent to form a terminal pin, and a welding portion is arranged at an end of the terminal pin; when the conductive terminal is fixed inside the insulating inner core, the terminal pin passes through the insulating inner core and extends out from a lower end of the insulating inner core; the conductive terminal is welded and fixed to the floating plate through the second pad; and the terminal pin is flexibly arranged to absorb swing deformation of the conductive terminal.

6. The floating radio frequency connector of claim 5, wherein the terminal pin is provided with a barbed portion, the insulating inner core is provided with a barbed clamping groove matching the barbed portion and an avoidance gap for an extension of the terminal pin, and the avoidance gap is arranged on a lower side wall of the insulating inner core; and when the conductive terminal is fixed inside the insulating inner core, the barbed portion is clamped and fixed inside the barbed clamping groove, and the terminal pin extends out from the lower side wall of the insulating inner core through the avoidance gap.

7. The floating radio frequency connector of claim 1, wherein an upper end of the floating outer conductor extends away from the floating central axis in the radial direction of the floating central axis and is bent to form a second elastic guide portion, the second guide portion is cambered, a guide slope is formed at an inlet of an insertion cavity of an external insert, and when the floating radio frequency connector is inserted into the external insert, the second guide portion is guided into the insertion cavity along the guide slope and constantly abuts against an inner wall of the insertion cavity.

8. The floating radio frequency connector of claim 1, wherein a plurality of elastic terminal sheets are arranged at an upper end of the conductive terminal, all the elastic terminal sheets jointly form a receiving cavity for inserting a terminal of the external insert, and when the terminal of the external insert is inserted into the receiving cavity, all the elastic terminal sheets jointly clamp the terminal of the external insert.

9. The floating radio frequency connector of claim 8, wherein the elastic terminal sheet extends radially away from the floating central axis and is bent to form a third elastic guide portion, the third guide portion is cambered, and when the terminal of the external insert is inserted into the receiving cavity, the terminal of the external insert is guided into the receiving cavity along the third guide portion.

10. The floating radio frequency connector of claim 1, wherein the floating radio frequency connector further comprises a first anti-rotating structure and a second anti-rotating structure, the first anti-rotating structure is used for limiting rotation between the floating outer conductor and the insulating inner core, and the second anti-rotating structure is used for limiting a swing angle of the floating outer conductor relative to the fixed outer conductor.

11. A mating floating radio frequency connector with offset tolerance, comprising a fixed outer conductor, wherein a connecting portion for being welded with a substrate is arranged at a bottom of the fixed outer conductor, and a joint with a convex portion is arranged on a top of the fixed outer conductor;
a floating outer conductor, wherein a sleeve in floating fit with the joint is arranged at a lower end of the floating outer conductor, and the sleeve is movably sleeved outside the joint;
an insulator, wherein the insulator is provided with a slot that runs through axially, and the insulator is fixedly mounted inside the floating outer conductor; and
a conductive terminal, wherein the conductive terminal is arranged inside the slot, a lower end of the conductive terminal extends out of the slot and is provided with a welding portion for connecting to the substrate, an upper portion of the conductive terminal is fixed with the insulator, and a middle portion of the conductive terminal is a flexible portion formed by bending.

12. The mating floating radio frequency connector with offset tolerance of claim 11, wherein a plurality of first elastic sheets are arranged on the top of the fixed outer conductor, the joint can be formed by bending middle portions of the plurality of first elastic sheets outward respectively, and convex portions in the middle portions of the plurality of first elastic sheets can elastically abut against an inner wall of the sleeve.

13. The mating floating radio frequency connector with offset tolerance of claim 12, wherein a limit portion bent inward is arranged at an opening of the sleeve, and the limit portion is used for limiting detachment and a swing amplitude of the floating outer conductor.

14. The mating floating radio frequency connector with offset tolerance of claim 11, wherein a hollow spherical crown is arranged on the top of the fixed outer conductor, and a convex portion at a maximum outer diameter of the spherical crown can abut against the inner wall of the sleeve in a sliding manner.

15. The mating floating radio frequency connector with offset tolerance of claim 14, wherein a limit portion bent inward is arranged at an opening of the sleeve, and the limit portion is used for limiting detachment and a swing amplitude of the floating outer conductor.

16. The mating floating radio frequency connector with offset tolerance of claim 14, wherein a second elastic sheet bent inward is arranged on the sleeve, and the spherical crown can elastically abut against the second elastic sheet.

17. The mating floating radio frequency connector with offset tolerance of claim 11, wherein the fixed outer conductor is of a hollow structure with openings at two ends, and the connecting portion is a flitch welding portion or a through plate welding pin arranged at a lower port of the fixed outer conductor.

18. The mating floating radio frequency connector with offset tolerance of claim 11, wherein a terminal of the conductive terminal is a pin.

19. The mating floating radio frequency connector with offset tolerance of claim 18, wherein the floating outer conductor is of a hollow structure with openings at two ends, a third elastic sheet protruding outward is arranged at an upper portion of the floating outer conductor, the third elastic sheet is bent, and an end of the third elastic sheet is a free end.

20. The mating floating radio frequency connector with offset tolerance of claim 11, wherein the terminal of the conductive terminal is a female terminal with a chamber.

21. The mating floating radio frequency connector with offset tolerance of claim 20, wherein the floating outer conductor is of a hollow structure with openings at two ends, a third elastic sheet protruding outward is arranged at the upper portion of the floating outer conductor, the third elastic sheet is bent, and an end of the third elastic sheet is a free end.
